(19) United States
(12) Patent Application Publication
(10) Pub. No.: US 2018/0025317 A1
(43) Pub. Date: Jan. 25, 2018

(54) FACILITATING USE AND MANAGEMENT OF SMART VEHICLES AND SMART VEHICLE INFRASTRUCTURE

(71) Applicant: AT&T Mobility II LLC, Atlanta, GA (US)

(72) Inventor: Brian Dominguez, Atlanta, GA (US)

(21) Appl. No.: 15/216,139

(22) Filed: Jul. 21, 2016

(51) Int. Cl. G06Q 10/08; G06Q 30/00

(52) U.S. Cl. CPC G06Q 10/0832; G06Q 30/018

(57) ABSTRACT

Management of smart vehicles and smart vehicle infrastructure are provided. A method comprises determining, by a device comprising a processor, rule information indicative of a rule governing cargo in a vehicle; determining, by the device, compliance with the rule based on comparing sensory information from a sensor about second cargo in the vehicle and the rule information; and performing, by the device, an action in response to the determining the compliance with the rule. In one embodiment, the rule information is associated with a policy specifying an illegality associated with the second object in the vehicle. Performing the action can comprise transmitting an alert signal to an agency device associated with an identity of a law enforcement agency based on the determining the compliance with the rule. In other embodiments, other possibilities and aspects are also provided.

### TECHNICAL FIELD

The subject disclosure relates generally to smart vehicles and to facilitating use and management of smart vehicles and smart vehicle infrastructure.

### BACKGROUND

Traditionally, vehicles have served the single purpose of the transportation of people and goods. These vehicles (e.g., cars, airplanes, boats) have been operated by live, on-site drivers who take responsibility for contents of the vehicles and/or maintenance of the same. The replacement of traditional vehicles by smart (e.g., including autonomous) vehicles facilitates functionality beyond mere transportation. However, issues regarding safety with smart vehicles can arise because, for example, a live on-site driver/pilot may not be present or may not be actively engaged in the cargo or traditional steering/navigation process. These safety concerns and associated risks pose a threat to fellow smart vehicle occupants as well as passersby in other vehicles or pedestrians.

Furthermore, there is a dearth of information regarding the current state of vehicle infrastructures (e.g., roadways) and maintenance of such infrastructure is often slow due to inefficiencies in approaches to monitoring and a disjointed system of communication between municipalities, drivers and other sources of information. Additionally, traffic flow management is a significant problem in major cities at times associated with rush hour, before or after events and, in some cases, in cities like Los Angeles, during off-peak hours. Accordingly, many opportunities exist for improvement of infrastructure and traffic flow management.

### BRIEF DESCRIPTION OF THE DRAWINGS

FIG. 1 illustrates an example block diagram of a system facilitating use and management of smart vehicles and smart vehicle infrastructure in accordance with one or more embodiments described herein.

FIG. 2 illustrates an example block diagram of a system facilitating use and management of smart vehicles and smart vehicle infrastructure in accordance with one or more embodiments described herein.

FIGS. 3, 4, 5, 6, 7, 8 and 9 illustrate example flowcharts of methods that facilitate use and management of smart vehicles and smart vehicle infrastructure in accordance with one or more embodiments described herein.

FIG. 10 illustrates a block diagram of a computer operable to facilitate use and management of smart vehicles and smart vehicle infrastructure in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

Traditionally, vehicles have served the single purpose of the transportation of people and goods. The replacement of traditional vehicles by smart vehicles facilitates functionality beyond mere transportation. However, issues regarding safety can arise with smart vehicles. For example, there is currently no way to monitor the contents being transported in a smart vehicle. Additionally, the use of smart vehicles provide opportunities to improve infrastructure for vehicles. One or more embodiments described herein can facilitate solutions that provide safety, peace-of-mind, optimization, and/or efficiency (e.g., route planning, time of transit and/or infrastructure finance efficiency) employing smart vehicles. One or more embodiments described herein can provide a comprehensive and targeted solution towards smart vehicles of the future. As used herein, the term “smart vehicles” can mean autonomous, semi-autonomous or remotely piloted vehicles. Further, as used herein, the term “vehicles” broadly encompasses cars, fleets, recreational machinery, drones, planes, ships, etc.

Embodiments described herein comprise systems, methods, apparatus and/or computer-readable storage media that facilitate smart vehicles and to facilitating management of smart vehicles and smart vehicle infrastructure. In one example embodiment, a method comprises: determining, by a device comprising of a processor, rule information indicative of a rule governing cargo in a vehicle; and determining, by the device, compliance with the rule based on comparing sensory information from a sensor about second cargo in the vehicle and the rule information. The method also comprises performing, by the device, an action in response to the determining the compliance with the rule.

In another example embodiment, a machine-readable storage medium is provided. The machine-readable storage medium comprises executable instructions that, when executed by a processor, facilitate performance of operations. The operations can comprise: facilitating sensor monitoring of cargo associated with a remotely piloted vehicle; and generating a first report of a first status of the remotely piloted vehicle relative to a risks associated with the cargo of the remotely piloted vehicle, wherein the risk is determined based on rules information related to oversight of the cargo. In various embodiments, risks can be defined by rules and/or may include legal, policy and/or preferences.

In another example embodiment, a system comprises a processor; and a memory that stores executable instructions that, when executed by the processor, facilitate performance of operations. The operations comprise: generating rules from a rules engine, wherein the rules engine is populated based on principles and regulations, and wherein the rules are employed to determine whether contents of a vehicle are in compliance with the rules. The operations also comprise receiving reported information based on converting information from raw data feeds from a sensor for the vehicle, wherein the reported information comprises a recommendation for an action based on the determination regarding whether the contents of the vehicle are in compliance with the rules. The operations also comprise receiving event management information indicative of a request for a deployment of resources associated with an infrastructure for the vehicle, wherein the event management information is generated based on environmental sensors and detection of a characteristic of an event.

One or more of the example embodiments described herein can provide information regarding the contents of one or more smart vehicles, which can significantly enhance safety of the use of these types of vehicles. Further, one or more of the example embodiments can generate associated analytics to provide predictions and alerts regarding anticipated impacts to a broad system that can be affected by these types of vehicles. The system that can be affected by these types of vehicles can comprise, but are not limited to, vehicle infrastructure systems, legal systems, policy systems and municipalities.

One or more of the example embodiments can provide speed of detection and alert information regarding contents in smart vehicles via one all-encompassing network of information transmission and compliance, resulting in an efficient seamless system. One or more of the example embodiments can provide for accuracy in location and identification of contents since sensors can detect and facilitate alerts regarding compliance conditions. One or more embodiments can provide efficiency via ongoing or periodic route optimization based on time of day, weather or road conditions, etc.

One or more of the example embodiments can generate value distribution with increased knowledge of route optimization, alerts, and events and corresponding opportunity to deliver and extract more value for fast lane scenarios. These scenarios can comprise, but are not limited to, emergency situations, commercial pay-for-speed lanes and/or credits for opting to a slow vehicle travel lane. One or more of the example embodiments can also generate safety and peace of mind that results from knowledge of smart vehicle contents and the alerts that would be triggered due to changes in compliance, creating a safer ecosystem.

In various embodiments, four main components of the systems described herein can provide timely delivery knowledge of the contents being transported in smart vehicles and comprise the associated analytics to alert impacts to the broader system (e.g., streamlining infrastructure, policy and legal compliance, etc.). This compliance and analytics solution for smart vehicles can comprise a compliance hub to manage parameters and monetization; a vehicle system to authenticate and/or monitor contents; an analytics platform to securely recommend and/or report; and a smart infrastructure device to serve predictive analytics and event management. One or more of the components can be connected via real-time or near-real time secure data transmissions. In some embodiments, additional variables and/or data feeds can be introduced by or to the smart infrastructure device.

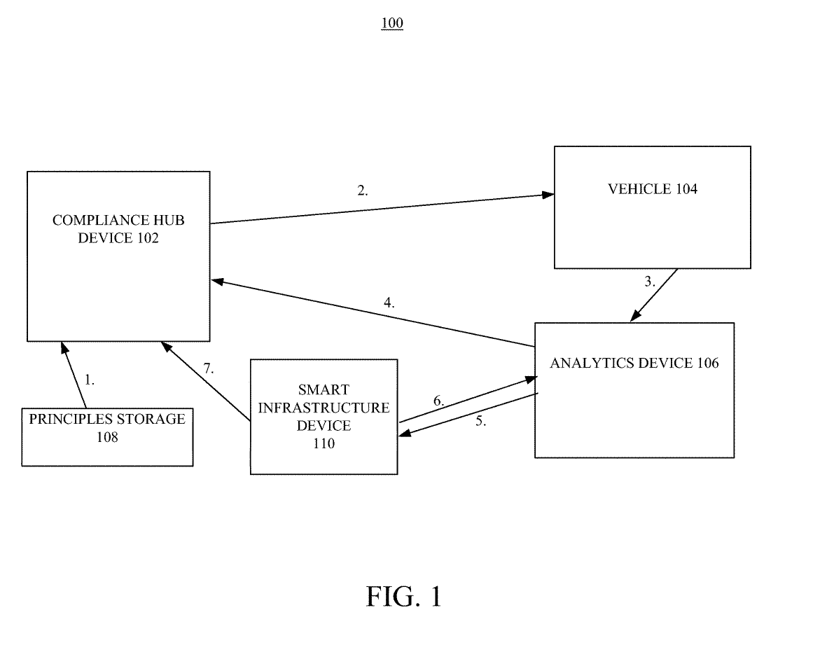

Turning now to the drawings, FIG. 1 illustrates an example block diagram of a system facilitating use and management of smart vehicles and smart vehicle infrastructure in accordance with one or more embodiments described herein. The system 100 can comprise a number of different components comprising those shown in FIG. 1. As shown, FIG. 1 can comprise a compliance hub device 102, principles storage 108, smart infrastructure device 110 and/or analytics device 106. In some embodiments, as shown, the system 100 can also comprise a vehicle 104. In some embodiments, the system 100 can comprise one or more vehicle sensors (which can be the same as or different than the other sensors described herein). In some embodiments, the compliance hub device 102, principles storage 108, smart infrastructure device 110, analytics device 106 and/or vehicle 104 can be electrically and/or communicatively coupled to one another to perform one or more functions of system 100.

Principles storage 108 can be or comprise a storage device or database that stores information regarding one or more rules or principles for governing contents of smart vehicles, smart vehicle infrastructure modifications, laws or policies regarding smart vehicles or smart vehicle infrastructure or the like. By way of example, but not limitation, in one example the principles storage 108 can store information such as prohibited contents of a vehicle, whether contents of a vehicle should trigger an alert to law enforcement, a minimum distance between two or more smart vehicles having defined or unknown contents, alerts for infrastructure maintenance, policies regarding bidding for fast lane access, event management data and the like.

In some embodiments, the principles storage 108 can include an interface (e.g., a cloud-based interface) that allows one or more system entities to input or feed principles (rules/laws/guidelines/parameters) into the principles storage 108 and/or to provide access to principles by the compliance hub device 102. These principles can be input from a participating organization, a legal or regulatory body, informed by government policies and/or can accommodate other principle inputs comprising, but not limited to, free-form and polling inputs that can represent preference shifts (e.g., real-time preference shifts from law enforcements, municipalities and the like).

Calls (e.g., in some embodiments, real-time calls) can be made via application programming interfaces (APIs) or other relevant, secure, low-latency (real-time or near real-time) mechanisms. In some embodiments, principles can be transmitted from the principles storage 108 to the compliance hub device 102. The compliance hub device 102 can maintain and house the guidelines and blueprint of which events are in compliance and out of compliance with the principles. Out-of-compliance events (e.g., contents that are out of compliance, etc.) can create defined actions which may comprise, but are not limited to: alerts, deployment of assistance/enforcement, and/or exception reporting.

In one or more embodiments, the principles storage 108 can output to the compliance hub device 102 one or more of rules information, principles or information for determination or generation of rules. While the drawing shown as FIG. 1 illustrates the principles storage 108 as being separate from the compliance hub device 102, in some embodiments, the principles storage 108 can be included as part of the compliance hub device 102. In some embodiments, the compliance hub device 102 can access or be communicatively coupled to the principles storage 108 via a network. In some embodiments, the compliance hub device 102 can include the principles storage 108.

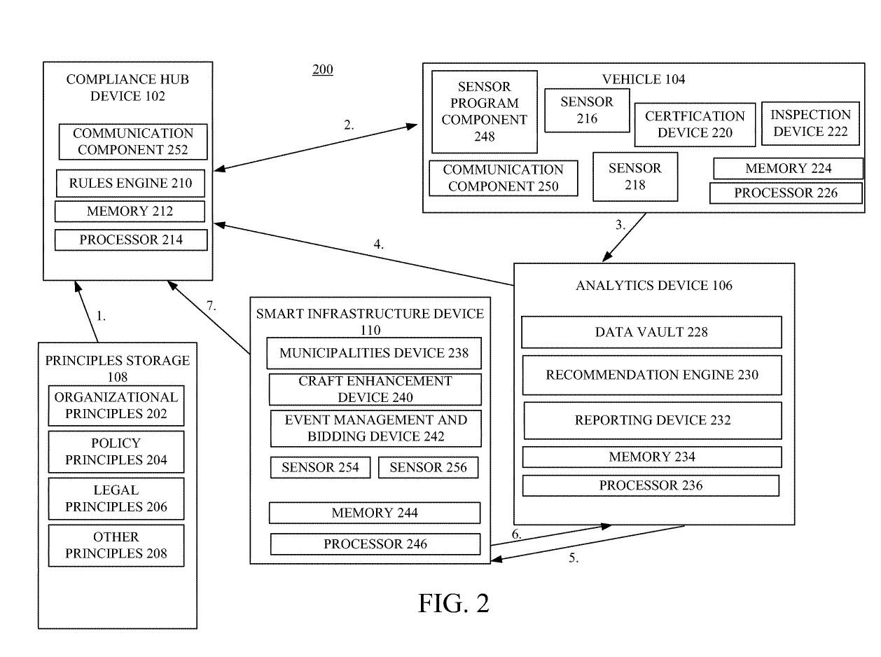

FIG. 2 illustrates an example block diagram of a system facilitating use and management of smart vehicles and smart vehicle infrastructure in accordance with one or more embodiments described herein. Repetitive description of like elements employed in respective embodiments of systems and/or apparatus described herein are omitted for sake of brevity. System 200 shows another embodiment of principles storage 108. In some embodiments, the principles storage 108 can include organizational principles 202, policy principles 204, legal principles 206 and other principles 208.

In some embodiments, the principles storage 108 can transmit rules information and/or policy information to the compliance hub device 102. The principles storage 108 can be configured to store and/or process information received at and/or accessed by the compliance hub device 102. As shown, the compliance hub device 102 can be a central device that can receive and transmit information from and/or to one or more components of the system. As shown, the compliance hub device 102 can receive information from the sensors 216, 218, principles storage 108, the smart infrastructure device 110 and/or the analytics device 106 and can transmit information to the vehicle 104. In some embodiments, the principle information and/or rules information can be maintained, processed and/or updated by the compliance hub device 102. For example, in some embodiments, systemic organizational, legal and/or policy rules or parameters can be maintained, processed and/or updated by the compliance hub device 102. The compliance hub device 102 can also determine and/or transmit information that can be employed to allow determination of alerts (in some embodiments, real-time alerts) from in the vehicle 104 and/or the analytics device 106. In some embodiments, as shown in FIG. 2, the compliance hub device 102 can also comprise or access a rules engine 210 that can analyze, generate and/or designate preferences, manage user or municipality accounts and/or generate information or parameters for monetization.

In some embodiments, the compliance hub device 102 can include an interface accessible by one or more different types of entities that can request and/or obtain information that the entity may have paid for (or that may be provided on a complimentary basis). For example, there can be one or more configurable rules or preferences for an entity account with the compliance hub device 102. The entity can then receive information or answers from the compliance hub device 102 based on reports, for example, generated in the analytics device 106 and/or generated in the smart infrastructure device 110 and received at the compliance hub device 102. Any number of different data sources can provide inputs to the compliance hub device 102. In various embodiments, the entities can be individuals, municipalities, cities or the like.

As shown in FIG. 2, in some embodiments, the compliance hub device 102 can comprise a communication component 252, rules engine 210, memory 212 and/or processor 214, which can be communicatively and/or electrically coupled to one another to perform one or more functions of the compliance hub device 102. The communication component 252 can comprise hardware, software and/or a combination of hardware and software configured to transmit and/or receive information to and/or from the principles storage 108, smart infrastructure device 110, vehicle 104 and/or analytics device 106. In some embodiments, the communication component 252 can output to the vehicle 104 one or more of rules information or rules from rules engine 210 for determining whether contents of the vehicle 104 are in compliance with the rules information. As used herein, in some embodiments, the terms “contents” and “cargo” can be interchangeable. In some embodiments, the communication component 252 can output to the vehicle 104 one or more of rules information or rules from rules engine 210 for determining whether an infrastructure is in need of updating or modification and/or whether a component of a vehicle complies with rules regarding wear and tear and operation of the components for safety and other concerns.

The vehicle 104 can be a smart vehicle and, as such, can comprise, but is not limited to, any autonomous, semi-autonomous or remotely piloted transportation vehicle (e.g., a car, a fleet of cars or vehicles, recreational vehicles, drones, airplanes, ships and the like). The rules information output to the vehicle 104 can differ depending on any number of different factors. By way of example, but not limitation, in one embodiment, the rules information can differ based on the type of the vehicle 104 (e.g., whether land-based, air-based or water-based), based on present or past risks or history of events associated with a particular vehicle 104 (e.g., a first risk or event associated with a smart car versus a second risk or event associated with a drone), based on whether specific rules or policies exist for a particular type of vehicle 104 (e.g., a first rule specified for cars versus a second rule specified for airplanes), based on the particular component of the vehicle 104 that is being monitored (e.g., a first rule for wear and tear on or operation of vehicle wheels versus a second rule for wear and tear on or operation of vehicle automated navigation system) and/or the type of infrastructure that a sensor of the vehicle can monitor (e.g., a first rule for street infrastructure in association with potholes, fast lane access and/or timing of street lights for traffic flow versus a second rule for infrastructure in association with control of air traffic and runway access).

In some embodiments, the compliance hub device 102 can streamline implementation of compliance principles for transportation vehicles. In various embodiments, these compliance principles can originate from a variety of sources comprising, but not limited to legal, regulatory, policy, organizational, and individual policies stored at and/or accessed from the principles storage 108.

As shown in FIG. 2, vehicle 104 can comprise one or more sensors 216, 218, a sensor program component 248, a communication component 250, a certification device 220, an inspection device 222, a memory 224 and/or a processor 226. In some embodiments, the one or more sensors 216, 218, sensor program component 248, communication component 250, certification device 220, inspection device 222, memory 224 and/or processor 226 can be electrically and/or communicatively coupled to one another to perform one or more functions of vehicle 104.

In some embodiments, the rules information can be received by the vehicle 104 and one or more operations of the vehicle 104 can be performed according to parameters or stipulations identified by the rules information. For example, the rules information can identify specific materials associated with explosive materials or illegal materials (e.g., illegal drugs) and/or hazardous products and/or specify one or more of an approach to enforcement regarding such materials or products. By way of example, but not limitation, the frequency of monitoring for such materials or products by a sensor of the vehicle 104 can be identified by the sensor program component 248 based on the rules information and the type or design of the one or more sensors 216, 218. The sensor program component 248 can be dynamically updated by the information transmitted from the compliance hub device 102 such that the manner in which the sensors 216, 218 operate can change from time to time based on a change in the rules or for any number of other factors.

In various embodiments, different types of sensors 216, 218 can be provided based on any number of factors (e.g., type of vehicle, type of content being monitored, type of environment or crowd event being monitored or anticipated, type of event being monitored or the like). In some embodiments, for example, the size or dimensions of contents in a vehicle 104 can be sensed with a first type of sensor while the chemical composition of contents can be sensed with another type of sensor. In some embodiments, one or more of the sensors can operate in conjunction with other sensors of other vehicles such that sensor 216 or sensor 218, for example, can determine whether the vehicle or contents of the vehicle are within a defined distance of another vehicle (that has, in different embodiments, the same, similar or different contents of the contents of vehicle 104).

In some embodiments, the sensors 216, 218 and/or the sensor program component 248 can be configured to receive and/or store compliance parameters and detect compliance of the content of the vehicle 104 with the rules information stored in the rules engine 210.

The rules engine 210 can be comprised or associated with the compliance hub device 102. Whereas there are principles created from multiple sources, and housed in a compliance hub device 102, how the rules are treated can be determined by the rules engine 210. The rules engine 210 can enable authorized users to designate preferences on compliance as well as conduct fundamental account management functions that may comprise, but are not limited to, methods of preferred communication, monetization (e.g., payment preferences, bidding rules, if applicable), security, privacy, schedules, records, and reporting requirements.

Once compliance principles are present, a component (e.g., sensor 216, 218) of vehicle 104 can determine the compliance with the principle. The rules information can comprise, but is not limited to: temperature, weight, passenger estimations (age, for example), quality of contents and quantity, characteristics and/or composition of contents. Accordingly, one or more of sensors 216, 218 can detect and output information to report contents and/or conditions associated with a vehicle 104.

In some embodiments, the compliance hub device 102 can transmit to the vehicle 104 one or more parameters (in some embodiments, in real-time or near real-time) for operation of the one or more sensors 216, 218 and/or for certification by certification device 220 and/or for inspection by inspection device 222. The certification device 220 can generate and/or evaluate certification information for the one or more sensors 216, 218 to ensure the accuracy of the sensors 216, 218, subject to regulatory certification inspection guidelines, as applicable. Accordingly, certification and/or authentication can occur to validate accuracy of one or more sensor 216, 218 outputs.

In some embodiments, the inspection device 222 can perform one or more inspections of the operation of the sensors 216, 218 and/or the data output from the sensors 216, 218 to determine and/or indicate data quality (e.g., data validity). In one example, the inspection device 222 can cause the sensors 216, 218 to conduct one or more or a series of steps or operations to determine whether the sensors 216, 218 have proper functionality. In some embodiments, a certification of satisfactory inspection can be provided once proper functionality and/or compliance is determined to be met.

The memory 224 can be a machine-readable storage medium storing computer-executable instructions to perform one or more of the functions described herein with reference to the vehicle 104, sensors 216, 218, sensor program component 248, inspection device 222 and/or certification device 220. For example, in some embodiments, the memory 224 can store information for performing inspection and/or certification of the sensors 216, 218 and/or for applying one or more rules information during or based on operation of the sensors 216, 218. The processor 226 can perform one or more of the functions described herein with reference to the vehicle 104 and/or sensors 216, 218 or other components of the vehicle 104.

In some embodiments, the vehicle 104 can output information to the analytics device 106. For example, the vehicle 104 can output from the one or more sensors 216, 218 raw data sensed by the sensors 216, 218. In some embodiments, the sensors 216, 218 and/or the sensor program component 248 can compare the information sensed with the rule information and determine whether the contents or components of the vehicle 104 satisfy or fail compliance requirements (rules information). In one embodiment, the information and/or raw data that is sensed can be output to the analytics device 106.

In some embodiments, the vehicle 104 can take one or more actions based on a determination that the contents and/or the components of the vehicle 104 fail the compliance requirement (rules information) comprising, but not limited to, generating an audible alert, transmitting an alert to one or more locations (e.g., law enforcement agency), generating a signal to cause the operation of the vehicle to safely cease or come to a stop at a nearby parking area, transmitting a signal to a manufacturer of a component of the vehicle 104 that should be updated or replaced, generating or transmitting information regarding the location/intersection/day/time at which the sensed materials or products were detected or any number of other actions. In some embodiments, information can be transmitted to the analytics device 106 and/or to the compliance hub device 102. One or more of the rules information can be modified and/or updated at the compliance hub device 102 and/or data can be updated, stored or predictions can be made at the analytics device 106, based on the information output from the vehicle 104 and/or communication component 250. In some embodiments, information regarding the contents and/or components satisfying the compliance requirements (rules information) can also be generated and/or transmitted in various embodiments.

In some embodiments, the analytics device 106 can comprise a platform to convert sensed information (e.g., which can be raw data feeds) from sensors 216, 218 at or associated with the vehicle 104 and/or compliance hub device 102 to information to assess compliance with the rules information or the rules. In some embodiments, the information to assess compliance with the rules information or the rules can be or include one or more configurable reports of the conclusions drawn from or associated with the raw data feeds. The analytics device 106 can comprise, but is not limited to, servers and/or a platform to draw insights or information out of raw data. As shown in FIG. 2, in some embodiments, the analytics device 106 can comprise a data vault 228, recommendation engine 230, reporting device 232, memory 234 and/or processor 236. In some embodiments, one or more of the data vault 228, recommendation engine 230, reporting device 232, memory 234 and/or processor 236 can be electrically and/or communicatively coupled to one another to securely perform one or more functions of analytics device 106.

In some embodiments, the data vault 228 can receive the raw data output from the one or more sensors 216, 218 and/or information indicative of a determination as to whether compliance has been satisfied for a content or component of vehicle 104. For example, the sensed information or raw data feed from the sensors 216, 218 of the vehicle 104 can be received by and/or accessed by the data vault 228 of the analytics device 106. In some embodiments, the data vault 228 can be a secure data vault that has limited access based on password protection or other security measures. In some embodiments, the information in the data vault 228 can be secured based on being anonymized, encrypted or the like. In various embodiments, the data vault 228 information can be processed and/or aggregated based on one or more characteristics and/or factors. By way of example, but not limitation, the data vault 228 can store various types of information comprising, but not limited to, raw data sensed by sensors 216, 218, information, recommendations or predictions regarding route optimization, warranty information, traffic patterns, etc.

The reporting device 232 can generate actionable reporting (e.g., one or more reports based upon which action is dictated, recommended or can be performed in the future). In some embodiments, the reporting device 232 can transmit a report to the compliance hub device 102. In some embodiments, the recommendation engine 230 can transmit a recommendation to the compliance hub device 102. The recommendation and/or the report can be transmitted upon receipt at or access by the analytics device 106, a defined amount of time after receipt by the analytics device 106 from the vehicle 104 or otherwise after access by the analytics device. In various embodiments, the analytics device 106 can receive and/or access the recommendation and/or report periodically, at a defined day/time, based on satisfaction of a defined condition, randomly or the like. Recommendations can be made regarding involvement of law enforcement, generations of bidding systems for fast lane or other access, changes in municipality infrastructure, contact of an OEM or any number of other types of information.

Predictions can be made based on any number of approaches, considerations, formulas, policies or the like. In one example, predictions of various variables can be made based on one or more known inputs (e.g., data sensed or otherwise determined). In some embodiments, information in the data vault 228 can be information that can be employed to generate the predictions and/or recommendations, comprising, but not limited to, traffic patterns, event details (e.g., time, day and/or location for sporting or other major events (e.g., conferences)), vehicle diagnostic data (e.g., wear and tear, braking patterns, fluid consumption/economy), location and transaction/commerce inputs as well. There is a wide set of data that could be collected, protected, anonymized and/or monetized.

In some embodiments, the analytics device 106 can receive information (or access information from the data vault 228) that the analytics device 106 can employ to generate the recommendation and/or report. With regard to transmission, the logic and raw data from the sensors 216, 218 can be analyzed, synthesized, and/or summarized by the analytics device 106. This can occur via a real-time or near real-time secure transmission to the analytics device 106 in some embodiments. Analytics can be performed based on the information being provided at or housed at the analytics device 106. In some embodiments, the analytics device 106 can generate value by securely storing data with options to anonymize, aggregate, encrypt data in a data vault that can be owned by data providers/ecosystem partners, but housed within an analytics bank (similar to an electronic safe deposit box), the recommendation engine 230 can provide trending information and predictive analytics to customers and smart infrastructures on metrics that may comprise, but are not limited to, route optimizations, warranty, search and/or the reporting device 232 can demonstrate compliance with rights, rules, etc. for individuals and compliance organizations. In some embodiments, the warehouse of data in the data vault 228 can enable various different types of predictions and recommendations.

In one embodiment, traffic pattern predictions can be made. Traffic pattern predictions can result in generation of information by the compliance hub device 102 or by other devices that comprise suggestions regarding when and/or how to facilitate commutes for a smart vehicle and/or when and/or how to make road repairs, for example. For example, traffic pattern predictions resulting in generation of information by the compliance hub device 102 can include, but is not limited to, the compliance hub device 102b provides a portal to request and access traffic pattern predictions. In some embodiments, generation of information can occur in the analytics device 106 and/or can be complemented by data from the smart infrastructure device 110. Any number of recommendations are possible.

In some embodiments, warranty information can be generated and transmitted (e.g., transmitted to OEMs) that can help OEMs manage costs proactively, encourage repairs in OEM shops (e.g., communications to customers to come to the OEM for repair before brakes or other components become unsafe). In some embodiments, new vehicle 104 features can be offered and/or determined for offer based on passenger behavior.

In some embodiments, recommendations about advertising can be determined and/or strategized based on a determination of one or more new or existing traffic patterns or information about users traveling in smart cars in a particular area (e.g., passengers most likely to have a propensity to buy a particular product can be determined and advertisers for that type of product can be notified and/or offered advertising space for purchase or use). In some embodiments, the determination of whether passengers are likely to purchase a particular type of product can be based on detected inputs at the vehicle 104 by one or more of the passengers. For example, a passenger can provide inputs received by the vehicle 104 regarding preferences of products. In one embodiment, the passenger can actively provide input. In another embodiment, the vehicle 104 or one or more sensors associated with the vehicle 104 can provide input (e.g., input based on the weight and/or biometrics of the passengers).

In some embodiments, the analytics device 106 can receive and/or process the raw data that was collected, compiled, analyzed (in the analytics device 106 and/or the vehicle 104) and transmit the data to the compliance hub device 102. The information can be or comprise reports created based on the sensors 216, 218 from vehicle 104. That information from the vehicle sensors 216, 218 can also be combined with other information to generate different reports or other higher-level or broader based information. In some embodiments, the analytics device 106 can combine information received from the smart infrastructure device 110 with information received from the vehicle 104 to generate other information.

The memory 234 can be a machine-readable storage medium storing computer-executable instructions to perform one or more of the functions described herein with reference to the analytics device 106 or components of the analytics device 106. For example, in some embodiments, the memory 234 can store information for generating recommendations, predictions and/or reports. The processor 236 can perform one or more of the functions described herein with reference to the analytics device 106.

In some embodiments, the recommendation and/or report generated by the analytics device 106 can be received by the SID 110 from the analytics device 106 or otherwise accessed by the SID 110. In some embodiments, the SID 110 can comprise a municipalities device 238, a craft enhancement device 240, an event management and bidding device 242, sensors 254, 256, memory 244 and/or processor 246.

Sensors 254, 256 can sense one or more aspects of an environment or infrastructure. By way of example, but not limitation, vehicle sensors as well as sensors for detection of natural disasters, amber alerts, large crowd events. One or more of the data from sensors of the vehicle 104 and/or sensors 254, 256 can be evaluated by the SID 110 and/or the analytics device 106. In some embodiments, the sensed data can be transmitted (e.g., via low-latency (real-time or near real-time) protocols to the analytics device 106).

The information from sensors 254, 256 can be analyzed and/or combined with other data or information from other sources (e.g., municipalities device 238, craft enhancement device 240, event management and bidding device 242 or the like). In some embodiments, data from the analytics device 106 that is fed into or received by the smart infrastructure device 110 can be or comprise tables and/or data lakes that are accessible by one another comprising, but not limited to, for example, linked spreadsheets in servers. In a more likely example, these can be or comprise huge data farms/lakes that transmit data through networked connections.

The SID 110 can generate information to inform and/or improve entities with predictive analytics, monetization and/or bidding to streamline or otherwise enhance transportation or reduce transportation-related driver issues. The SID 110 can employ information regarding or take into account municipalities, event management and bidding and/or vehicle optimization (e.g., air, water, road infrastructures). In some embodiments, the SID 110 can transmit the information and/or prediction information, monetization information and/or bidding information to the compliance hub device 102.

In some embodiments, the event management and bidding device 242 can generate information for management of infrastructure (e.g., facilitation of crowd control) based on events (e.g., sporting events, conferences, natural disasters or any other circumstance that can impact current transportation). The event management and bidding device 242, for example, can generate information requesting or planning more or different bus routes, management of train or public transportation schedules, deployment of road repair crews, etc. based on the knowledge of one or more characteristics of an event.

In some embodiments, the event management and bidding device 242 can predict one or more travel routes for vehicle travel based on one or more sensed or determined past, current or future events. In some embodiments, given an event, the event management and bidding device 242 can generate information to make it easier for people to move from one place to another. This could be based on daily commute information in some embodiments.

In some embodiments, a prediction can be made by the event management and bidding device 242 or another component of systems 100, 200 based on the time of day (e.g., lunchtime) and the weight of passengers in a vehicle 104 (e.g., 50 pounds of weight sensed in the back seat of the vehicle 104) to offer a restaurant coupon if a particular is determined to be nearby. In some embodiments, an offer can be digital information (e.g., a digital coupon) delivered to the vehicle 104 in a configurable way (to a passenger's device, to a head unit of the vehicle 104 and/or to the vehicle 104 in another manner so that the vehicle 104 itself serves as a coupon when in the proximity of a particular vendor—such as in a drive-thru or restaurant parking lot).

In another example, the event management and bidding device 242 can generate or utilize information about one or more different city events, the time of the events and proactively recommend in the future that vehicles take different routes to minimize traffic. In some embodiments, event management and bidding device 242 can create alerts and potentially even bidding opportunities for streamlining traffic. By way of example, but not limitation, travelers may have optimized/prioritized routes available (for pay travelers can pay based on systems established by the event management and bidding device 242). The routes can be based on traffic/location data (e.g., travelers can pay more to get to an event on time given the current state of events and time of such events). This is but one example of the manner in which monetization can be employed. By way of another example, but not limitation, original equipment manufacturers of a vehicle 104 can pay for research to be performed regarding new features that may be of interest to the passenger. Numerous other embodiments are also possible and envisaged.

To support ongoing improvements and a feedback loop, the compliance hub device 102 can receive feedback data from one or more different sources comprising, but not limited to, analytics device 106, SID 110 or the vehicle 104. This can increase the likelihood of ensuring real-time alerts and maintenance reporting requirements are met. In some embodiments, assuming the legal or policy rights are in place, data may improve and inform municipalities of not only traffic and route optimization, and preventative care but also can involve a safety/authority dispatch in the event that a compliance parameter involves legal issues. For example, the framework described herein can accommodate applicable laws and policies. One or more embodiments can take into account and/or accommodate various different policies organizations, governments, individuals may develop.

In some embodiments, the SID 110 can generate information indicative of or that can be employed to provide vehicle route optimization such as maintenance of roadways or docking stations for boats or the like. In some embodiments, traffic flow management can be enhanced based on the SID 110 generating information regarding route optimization and flow management based on any number of factors. By way of example, but not limitation, the route optimization and/or traffic flow management can comprise different directives and/or information or planning information based on time-of-day, weather or road conditions, events, etc.).

In some embodiments, the SID 110 can generate information or recommendations to improve operations and/or planning of law enforcement and other municipality services. In some embodiments, the analytics device 106 and/or the SID can generate and/or perform predictive analytics regarding impending warranty claims or preventative maintenance. For example, such predictive analytics can be based on conditions of one or more components of the vehicle 104 monitored by the sensors 216, 218.

In some embodiments, the SID 110 and/or the analytics device 106 can generate information that can be provided to vehicle manufacturers for future business or product planning, determining improvements to vehicle components, etc. This information can be based on predictive analytics regarding behavior and future preferences for enhanced smart vehicle operations. In some embodiments, information can be generated based on monitored or forecasted traffic flow and/or corresponding needs for smart vehicles.

The craft enhancement device 240 can generate information describing recommendations that can comprise recommended offers and/or features based on behavior, insurance, etc. In one example, if new sensors gather information and indicate preferences, patterns, behavior, traffic patterns, then the craft enhancement device 240 can generate information about new features that could be created and/or for vehicle or infrastructure enhancement or optimization. In another example, new seats can be designed because of new information of how people prefer to sit. Offers/advertising can be sent based on data.

Accordingly, with sensors 216, 218, 254, 256, analytics, and an analytics device 106, content of a vehicle 104 can be known or monitored by not only a pilot but also relevant compliance/optimization organizations. To comply with regulation, provide peace-of-mind, and improve the safety of vehicles, the systems 100, 200 can discover, monitor, report smart vehicle status (e.g., condition, legality, health/well-being) and changes, as well as risks of the vehicle and contents. Additionally, with the associated data comes the opportunity for potential systemic infrastructure improvements and a bidding platform to manage events (pay or prioritize faster transportation based on economic, strategic, crises/societal value).

Information and/or alerts can systemically generate or feed smart infrastructure improvements from or within the SID 110 and/or the compliance hub device 102 back to devices for entities (e.g., municipalities devices 238, event management and bidding device 242, craft enhancement device 240) that can comprise municipalities, event administrators and/or the OEMs for the vehicle 104.

Numerous embodiments are possible with one or more embodiments described herein. One or more embodiments can facilitate accuracy: location, cargo contents, time are all significantly improved when sensors can detect and alert compliance conditions. For example, an event today where an illegal substance is transported through a traffic jam, means law enforcement would be looking for a needle in a haystack. In contrast, employing one or more embodiments described herein can have been flagged in a compliance hub device 102, sensed/reported in real-time through sensors 216, 218, and addressed/dispatched with pinpoint accuracy. This speed example can be extended to many other content alerts that are impacted by temperature, air quality, sound, time, etc.—these are embodiments in which time of reporting and/or alerts may have a significant effect on ability to manage and/or address issues or potential damage or issues.

One or more embodiments can facilitate value distribution: with increased knowledge of route optimization, alerts, and events comes the opportunity to deliver and extract more value for scenarios in which limited fast lane road access is provided for travelers or smart vehicles willing to pay for such access. These scenarios may comprise, but are not limited to, emergency situations, commercial pay-for-speed lanes and/or credits for opting to a slow lane of a road. Value can also be created/extracted via more robust data to serve offers in vehicles (for example, sensor knowledge of passengers, time of day, or location may prompt discounted meal offers by participating ecosystem partners). Professional and potential insurance services can be employed for advice in leveraging the participating partners of systems 100, 200 as well as for certifications and audit accuracy.

One or more embodiments can facilitate safety: peace-of-mind that comes with knowledge of autonomous vehicle contents and the alerts that would be triggered due to changes in compliance, creates a safer ecosystem. Additionally, infrastructure improvements and management of prioritized vehicle traffic creates a transportation environment less prone to erratic driving conditions due to emergencies. Privacy can also be a benefit from data vaults where information is stored in a similar model to bank vaults where ownership of data is retained, while in this case still accessible in anonymized, aggregated, and secure manners.

One or more embodiments can facilitate speed: when there is one, all-encompassing network of information transmission and compliance, the entire system can be faster than the manual disjointed methods. The system can span cloud-based portals, real-time APIs and transmission of data, vehicle sensors/information, analytics engines, smart infrastructure (cities, municipalities, etc.) and reporting.

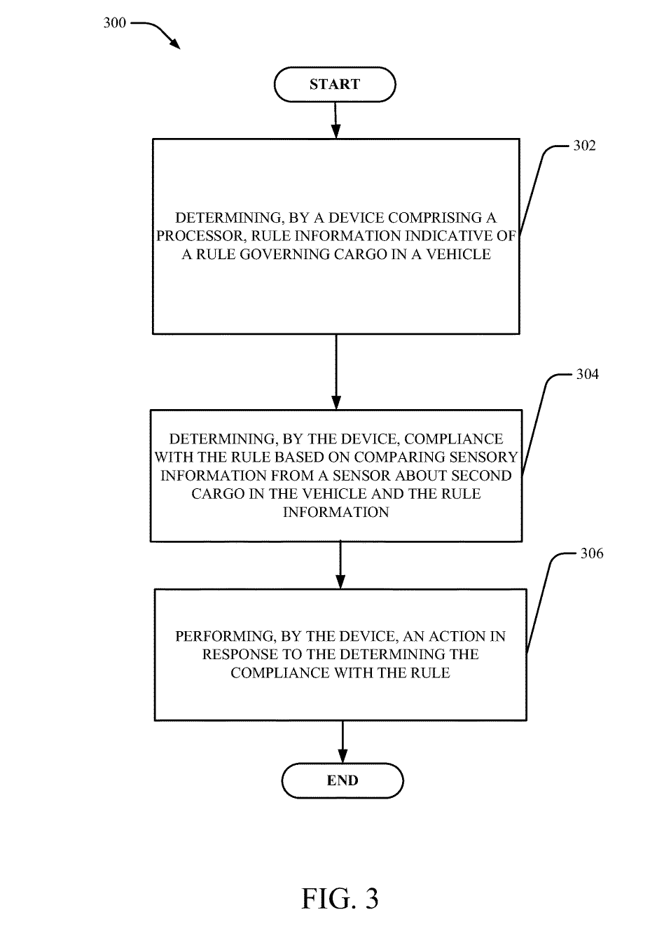

FIGS. 3, 4, 5, 6, 7, 8 and 9 illustrate example flowcharts of methods that facilitate management of smart vehicles and smart vehicle infrastructure in accordance with one or more embodiments described herein. Turning first to FIG. 3, at 302, method 300 can comprise determining, by a device comprising a processor, rule information indicative of a rule governing cargo in a vehicle. At 304, method 300 can comprise determining, by the device, compliance with the rule based on comparing sensory information from a sensor about second cargo in the vehicle and the rule information. At 306, method 300 can comprise performing, by the device, an action in response to the determining the compliance with the rule.

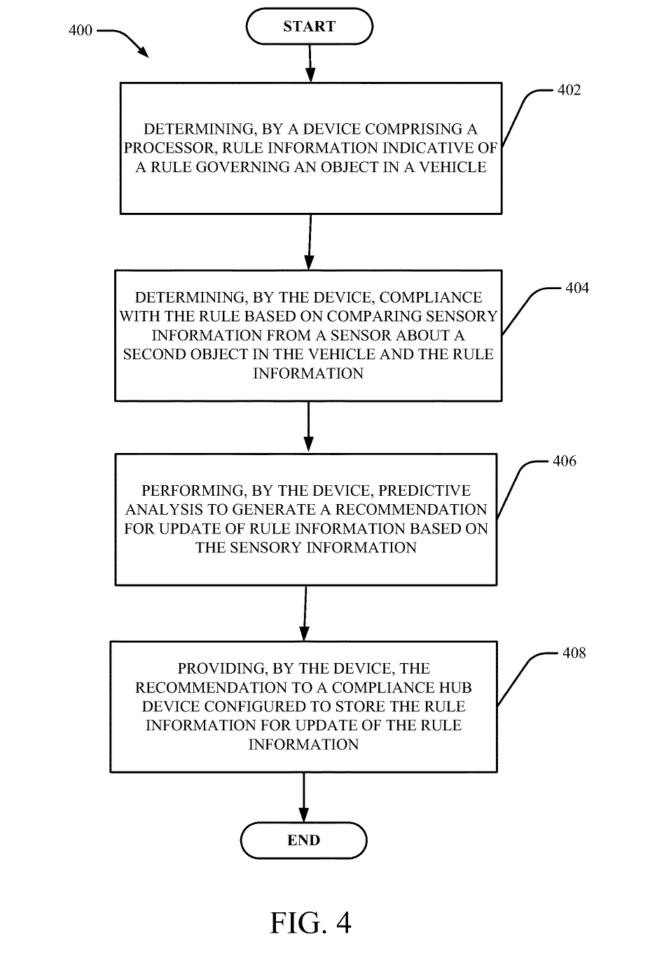

Turning now to FIG. 4, at 402, method 400 can comprise determining, by a device comprising a processor, rule information indicative of a rule governing an object in a vehicle. At 404, method 400 can comprise determining, by the device, compliance with the rule based on comparing sensory information from a sensor about a second object in the vehicle and the rule information. At 406, method 400 can comprise performing, by the device, predictive analysis to generate a recommendation for update of rule information based on the sensory information. At 408, method 400 can comprise providing, by the device, the recommendation to a compliance hub device configured to store the rule information for update of the rule information.

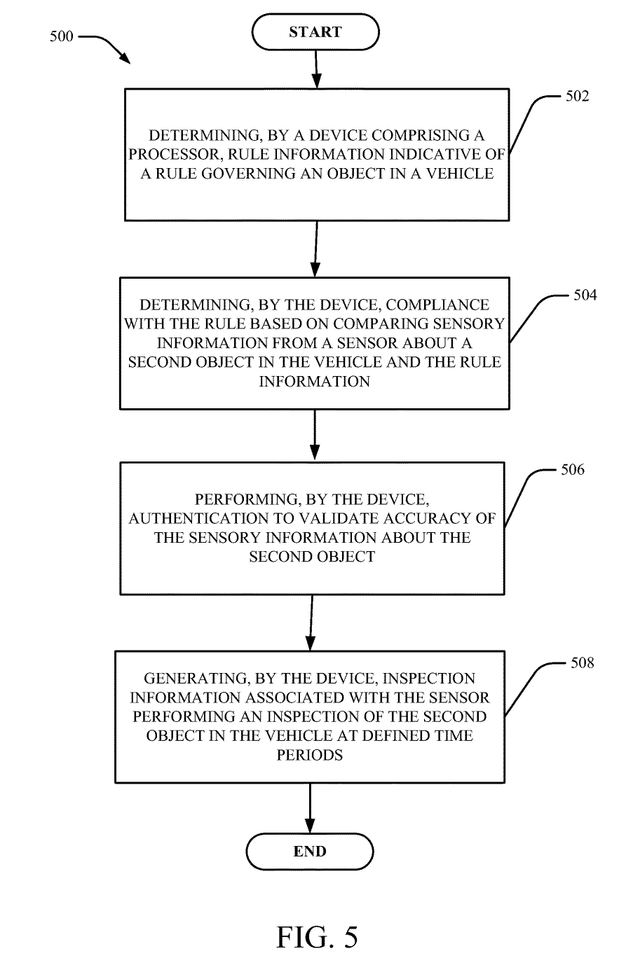

Turning now to FIG. 5, at 502, method 500 can comprise determining, by a device comprising a processor, rule information indicative of a rule governing an object in a vehicle. At 504, method 500 can comprise determining, by the device, compliance with the rule based on comparing sensory information from a sensor about a second object in the vehicle and the rule information. At 506, method 500 can comprise performing, by the device, authentication to validate accuracy of the sensory information about the second object. At 508, method 500 can comprise generating, by the device, inspection information associated with the sensor performing an inspection of the second object in the vehicle at defined time periods.

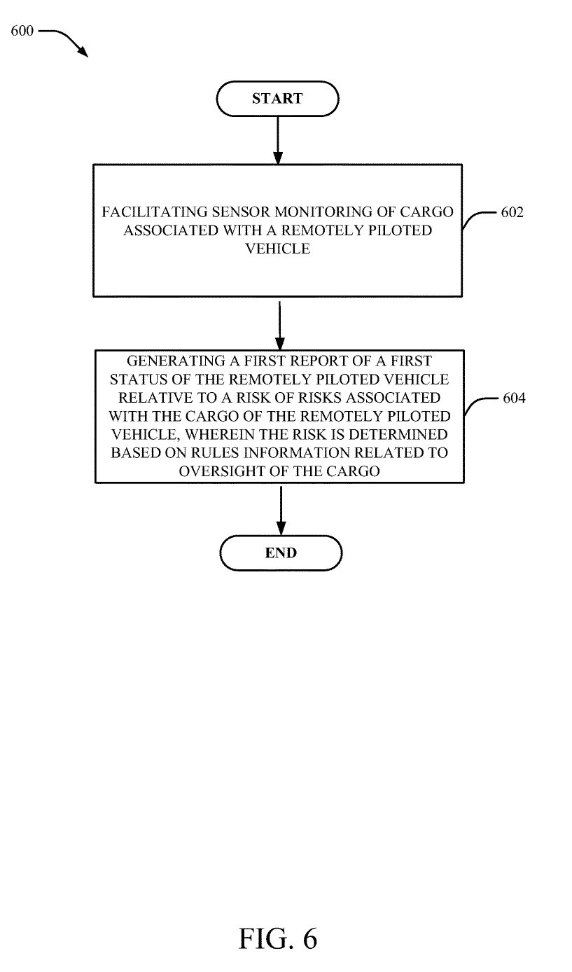

Turning now to FIG. 6, at 602, method 600 can comprise facilitating sensor monitoring of cargo associated with a remotely piloted vehicle. At 604, method 600 can comprise generating a first report of a first status of the remotely piloted vehicle relative to risks associated with the cargo of the remotely piloted vehicle, wherein the risks are determined based on rules information related to oversight of the cargo.

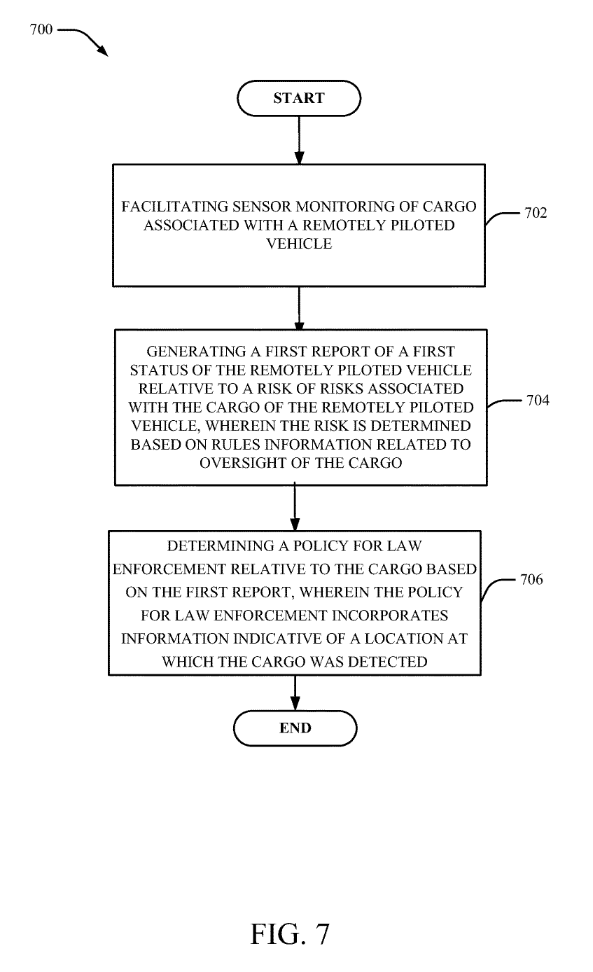

Turning now to FIG. 7, at 702, method 700 can comprise facilitating sensor monitoring of cargo associated with a remotely piloted vehicle. At 704, method 700 can comprise generating a first report of a first status of the remotely piloted vehicle relative to risks associated with the cargo of the remotely piloted vehicle, wherein the risks are determined based on rules information related to oversight of the cargo. At 706, method 700 can comprise determining a policy for law enforcement relative to the cargo based on the first report, wherein the policy for law enforcement incorporates information indicative of a location at which the cargo was detected.

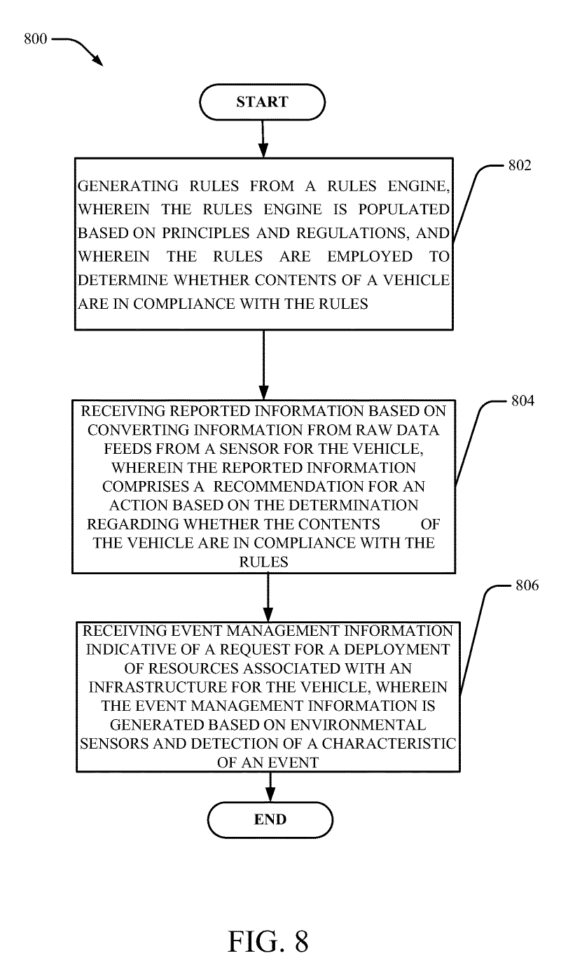

Turning now to FIG. 8, at 802, method 800 can comprise generating rules from a rules engine, wherein the rules engine is populated based on principles and regulations, and wherein the rules are employed to determine whether contents of a vehicle are in compliance with the rules. At 804, method 800 can comprise receiving reported information based on converting information from raw data feeds from a sensor for the vehicle, wherein the reported information comprises a recommendation for an action based on the determination regarding whether the contents of the vehicle are in compliance with the rules. At 806, method 800 can comprise receiving event management information indicative of a request for a deployment of resources associated with an infrastructure for the vehicle, wherein the event management information is generated based on environmental sensors and detection of a characteristic of an event.

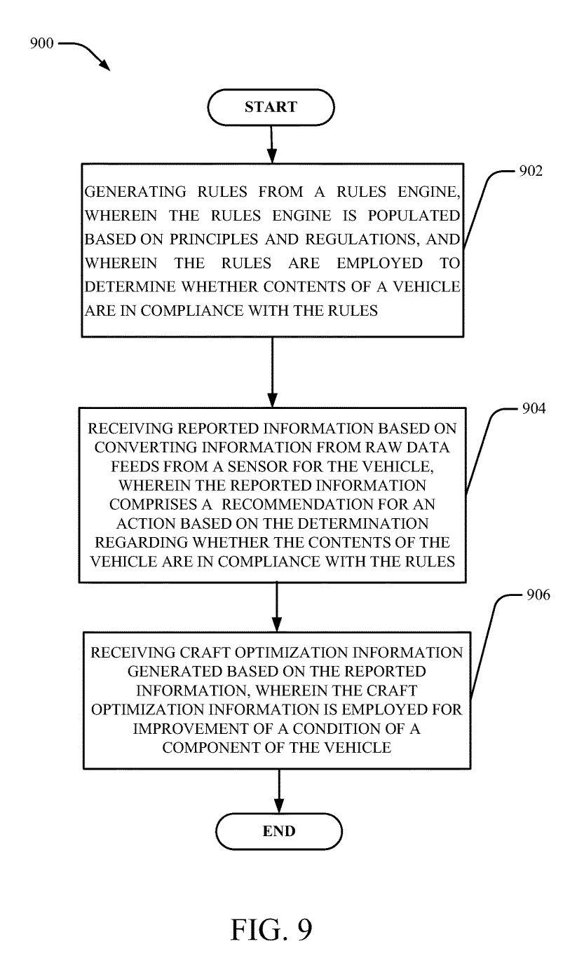

Turning now to FIG. 9, at 902, method 900 can comprise generating rules from a rules engine, wherein the rules engine is populated based on principles and regulations, and wherein the rules are employed to determine whether contents of a vehicle are in compliance with the rules. At 904, method 900 can comprise receiving reported information based on converting information from raw data feeds from a sensor for the vehicle, wherein the reported information comprises a recommendation for an action based on the determination regarding whether the contents of the vehicle are in compliance with the rules. At 906, method 900 can comprise receiving vehicle optimization information generated based on the reported information, wherein the vehicle optimization information is employed for improvement of a condition of a component of the vehicle.

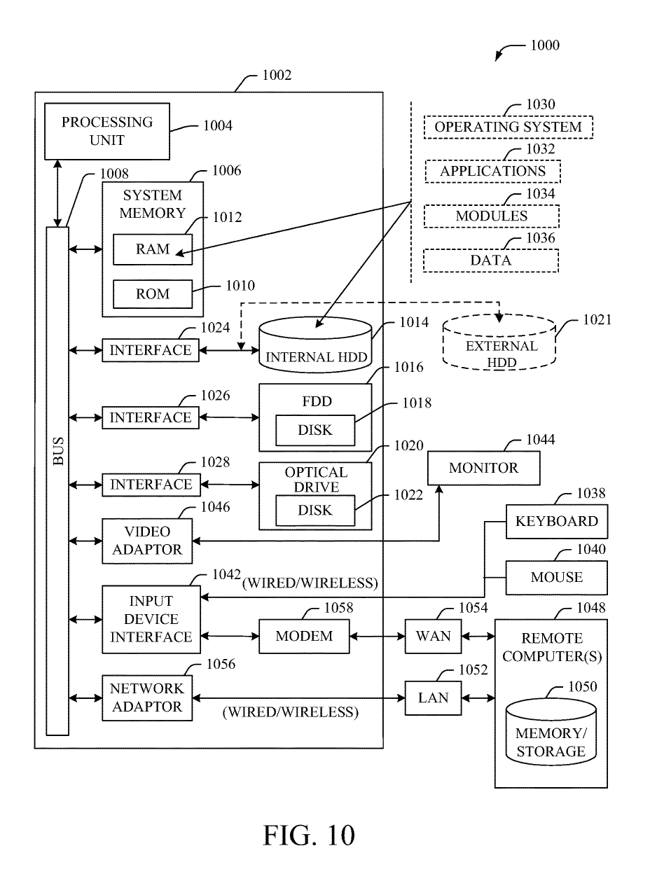

FIG. 10 illustrates a block diagram of a computer operable to facilitate management of smart vehicles and smart vehicle infrastructure in accordance with one or more embodiments described herein. For example, in some embodiments, the computer can be or be comprised within any number of components described herein comprising, but not limited compliance hub device 102, vehicle 104, analytics device 106, SID 110 and/or principles storage 108 (and/or any components of compliance hub device 102, vehicle 104, analytics device 106, SID 110 and/or principles storage 108).

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Tangible and/or non-transitory computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable media, is to be understood to exclude only propagating intangible signals per se as a modifier and does not relinquish coverage of all standard storage, memory or computer-readable media that are not only propagating intangible signals per se.

In this regard, the term “non-transitory” herein as applied to storage, memory or computer-readable media, is to be understood to exclude only propagating transitory signals per se as a modifier and does not relinquish coverage of all standard storage, memory or computer-readable media that are not only propagating transitory signals per se.

Communications media typically embody computer-readable instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 10, the example environment 1000 for implementing various embodiments of the embodiments described herein comprises a computer 1002, the computer 1002 comprising a processing unit 1004, a system memory 1006 and a system bus 1008. The system bus 1008 couples system components comprising, but not limited to, the system memory 1006 to the processing unit 1004. The processing unit 1004 can be any of various commercially available or proprietary processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 comprises ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also comprise a high-speed RAM such as static RAM for caching data.

The computer 1002 further comprises an internal hard disk drive (HDD) 1013 (e.g., EIDE, SATA), which internal hard disk drive 1013 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface, respectively. The interface 1024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, comprising an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A mobile device can enter commands and information into the computer 1002 through one or more wired/wireless input devices, e.g., a keyboard 1038 and a pointing device, such as a mouse 1040. Other input devices (not shown) can comprise a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. In addition to the monitor 1044, a computer typically comprises other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically comprises many or all of the elements described relative to the computer 1002, although, for purposes of brevity, only a memory/storage device 1050 is illustrated. The logical connections depicted comprise wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1052 through a wired and/or wireless communication network interface or adapter 1056. The adapter 1056 can facilitate wired or wireless communication to the LAN 1052, which can also comprise a wireless AP disposed thereon for communicating with the wireless adapter 1056.

When used in a WAN networking environment, the computer 1002 can comprise a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

As used in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS device),” “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “mobile device,” “subscriber,” “customer,” “consumer,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a mobile device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing mobile device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of mobile device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above represent mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
determining, by a device comprising a processor, rule information indicative of a rule governing cargo in a vehicle;
determining, by the device, compliance with the rule based on comparing sensory information from a sensor about second cargo in the vehicle and the rule information; and
performing, by the device, an action in response to the determining the compliance with the rule.

2. The method of claim 1, wherein the rule information is associated with a policy specifying an illegality associated with the second cargo in the vehicle.

3. The method of claim 2, wherein the performing the action comprises transmitting an alert signal to an agency device associated with an identity of a law enforcement agency based on the determining the compliance with the rule.

4. The method of claim 1, wherein the rule governing the object comprises a rule indicating no two vehicles within a defined distance of one another are able to include the cargo.

5. The method of claim 1, wherein the vehicle comprises an autonomous vehicle.

6. The method of claim 5, wherein the autonomous vehicle comprises a train.

7. The method of claim 5, wherein the autonomous vehicle comprises an airplane.

8. The method of claim 1, further comprising:
performing, by the device, an authentication to validate accuracy of the sensory information about the second cargo.

9. The method of claim 8, further comprising:
generating, by the device, inspection information associated with the sensor performing an inspection of the second cargo in the vehicle at defined time periods.

10. The method of claim 1, wherein the performing action comprises transmitting a notification to a manufacturer of a component of the vehicle regarding a state of the component.

11. The method of claim 1, further comprising:
performing, by the device, a predictive analysis to generate a recommendation for update of rule information based on the sensory information; and
providing, by the device, the recommendation to a compliance device configured to store the rule information for update of the rule information.

12. A machine-readable storage medium, comprising executable instructions that, when executed by a processor, facilitate performance of operations, comprising:
facilitating a sensor to monitor cargo associated with a remotely piloted vehicle; and
generating a first report of a first status of the remotely piloted vehicle relative to a risk of risks associated with the cargo of the remotely piloted vehicle, wherein the risk is determined based on rules information related to oversight of the cargo.

13. The machine-readable storage medium of claim 12, wherein the operations further comprise determining a policy for law enforcement relative to the cargo based on the first report.

14. The machine-readable storage medium of claim 13, wherein the policy for law enforcement incorporates information indicative of a location at which the cargo was detected.

15. The machine-readable storage medium of claim 14, wherein the operations further comprise:
facilitating the sensor to monitor a condition of a component associated with the remotely piloted vehicle; and
performing an action based on receiving condition information representing the condition of the component of the remotely piloted vehicle from the sensor.

16. The machine-readable storage medium of claim 15, wherein performing the action comprises generating a recommendation for vehicle transportation infrastructure modification based on the condition of the component.

17. The machine-readable storage medium of claim 12, wherein the rules information comprises a rule that prohibits the cargo to be within a defined distance of a same type of cargo.

18. The machine-readable storage medium of claim 15, wherein the performing the action comprises transmitting a report about the component based on the condition of the component.

19. A system, comprising:
a processor; and
a memory that stores executable instructions that, when executed by the processor, facilitate performance of operations, comprising:
generating rules from a rules engine, wherein the rules engine is populated according to principles and regulations, and wherein the rules are employed to determine whether contents of a vehicle are in compliance with the rules;
receiving reported information based on converting information from raw data feeds from a sensor for the vehicle, wherein the reported information comprises a recommendation for an action based on the determination regarding whether the contents of the vehicle are in compliance with the rules; and
receiving event management information indicative of a request for a deployment of resources associated with an infrastructure for the vehicle, wherein the event management information is generated based on environmental sensors and detection of a characteristic of an event.

20. The system of claim 19, wherein the operations further comprise updating a rule of the rules based on the receiving the reported information.
